(19) United States
(12) Patent Application Publication
(10) Pub. No.: US 2025/0303936 A1
(43) Pub. Date: Oct. 2, 2025

(54) OPERATOR SEAT

(71) Applicant: DEERE & COMPANY, MOLINE, IL (US)

(72) Inventors: MICHAEL W. THOMPSON, CLAYTON, IN (US); BRIAN M. HUENINK, CEDAR GROVE, WI (US); GREGORY O. MCCONOUGHEY, LECLAIRE, IA (US)

(21) Appl. No.: 18/624,202

(22) Filed: Apr. 2, 2024

(51) Int. Cl. B60N 2/50; B60N 2/22; B60N 2/24; B60N 2/54

(52) U.S. Cl. CPC B60N 2/504; B60N 2/2227; B60N 2/24; B60N 2/544

(57) ABSTRACT

An operator seat of a work vehicle includes a seat base, a support, a flange, and a suspension apparatus. The seat base has a base frame. The support extends upward from a rearward portion of the seat base. The backrest is rotatably coupled to the seat base with the support and reclinable relative to the seat base. The flange is coupled to the support and rotatable relative to the support around a first axis. The suspension apparatus is coupled between the flange and the backrest to provide rotation between the flange and the backrest around the first axis. The rotation of the flange rotates the suspension apparatus.

### TECHNICAL FIELD

The present disclosure relates generally to a vehicle, in particular to a seat of a work vehicle.

### BACKGROUND

A vehicle, such as a work vehicle, normally provides a seat for an operator to operate the vehicle. The seat may include a backrest and the operator may lean back on the backrest for comfort. During the operation of the work vehicle, the operator may lean forward and backward occasionally.

### SUMMARY

According to a disclosure, an operator seat of a work vehicle includes a seat base, a support, a flange, and a suspension apparatus. The seat base has a base frame. The support extends upward from a rearward portion of the seat base. The backrest is rotatably coupled to the seat base with the support and reclinable relative to the seat base. The flange is coupled to the support and rotatable relative to the support around a first axis. The suspension apparatus is coupled between the flange and the backrest to provide rotation between the flange and the backrest around the first axis. The rotation of the flange rotates the suspension apparatus.

In one aspect of the disclosure, the suspension apparatus includes a bracket, a fastener, a retaining piece. The bracket is coupled to a side of the backrest, and rotatable with the flange with the suspension allowing a limited rotation relative to the flange around the first axis. The bracket has an aperture. The retaining piece is connected to the flange by the fastener passing through the aperture of the bracket. The bracket is positioned between the flange and the retaining piece.

In one aspect of the disclosure, the suspension apparatus includes a spring having a first end coupled to the bracket and a second end coupled to the retaining piece to resist the bracket from the limited rotation through a spring force from the spring.

In one aspect of the disclosure, the suspension apparatus includes a bolt and a nut. The bolt has a bolt head and a body connected to the bolt head. The spring surrounds body of the bolt and is positioned between the bolt head and the nut, and one of the bolt head and the nut engages the bracket and the other one of the bolt head and the nut engages the retaining piece. The bolt is turnable relative to the nut to change a pre-load of the spring.

In one aspect of the disclosure, the bracket extends a first lobe and the retaining piece extends a second lobe spaced apart from the first lobe with a distance. The first lobe is positioned between the first end of the spring and one of the bolt head and the nut, and the second lobe is positioned between the second end of the spring and the other one of the bolt head and the nut.

In one aspect of the disclosure, the spring is a compression spring. The spring is configured to provide the suspension to absorb impact that increases a reclination angle between the backrest and the seat base and decreases the distance when the first lobe moves toward the second lobe.

In one aspect of the disclosure, the body of the bolt includes a first shoulder, one end of the first shoulder connected to the bolt head, and a second shoulder connected to another end of the first shoulder. The diameter of the second shoulder is smaller than the diameter of the first shoulder. The suspension apparatus includes a collar abutting one of the first lobe and the second lobe with the nut on an opposite side relative to the first lobe or the second lobe, pressing one of the first end and the second end of the spring, and moveable along the second shoulder to compress the spring with a boundary at the first shoulder for a maximum pre-load setting.

In one aspect of the disclosure, the spring is the expansion spring. The spring is configured to provide the suspension to absorb impact that increases a reclination angle between the backrest and the seat base.

In one aspect of the disclosure, the bracket extends a first lobe and the retaining piece extends a second lobe spaced apart from the first lobe with a distance. The first end of the spring is connected to the first lobe and the second end of the spring is connected to the second lobe.

In one aspect of the disclosure, the operator seat has a reclination adjustment apparatus, which includes the flange, an actuator and a connector driven by the actuator. The flange is coupled to an end of the connector, and the actuator drives the connector to rotate the flange relative to the support.

In one aspect of the disclosure, the flange protrudes inward a platform having a rim inserting to the aperture of the bracket. The bracket is rotatable in the limited rotation relative to the rim of the flange.

In one aspect of the disclosure, the retaining piece is connected to the platform of the flange through the fastener.

In one aspect of the disclosure, the operator seat has a lock-out device engaging between the bracket and one of the flange and retaining piece. The lock-out device is configured to prevent the bracket from the limited rotation relative to the flange around the first axis.

In one aspect of the disclosure, the suspension apparatus includes an elastomer bushing coupled between the flange and the backrest.

In one aspect of the disclosure, the suspension apparatus includes a bracket coupled to a side of the backrest and reclinable with the flange with the suspension allowing a limited rotation relative to the flange around the first axis. The elastomer bushing includes an inner sleeve coupled to the flange, an outer sleeve coupled to the bracket, and an elastomer positioned between the inner sleeve and outer sleeve and configured to provide the suspension.

Other features and aspects will become apparent by consideration of the detailed description, claims, and accompanying drawings.

### BRIEF DESCRIPTION OF THE DRAWINGS

The detailed description of the drawings refers to the accompanying figures.

FIG. 1 is a simplified side view of an example work vehicle in the form of a tractor.

FIG. 2 is a top front perspective view of a cab interior of the work vehicle of FIG. 1.

FIG. 3 is a perspective view of an operator seat.

FIG. 4 is a partial enlarged view of the operator seat in FIG. 3 with cushions omitted.

FIG. 5 is a perspective view of a first implementation of a suspension apparatus of the operator seat in FIG. 3.

FIG. 6 is an exploded view of the first implementation of the suspension apparatus.

FIG. 7 is another exploded view of the first implementation of the suspension apparatus.

FIG. 8A is a side view of the first implementation of the suspension apparatus when there is no force to recline a backrest of the operator seat.

FIG. 8B is a side view of the first implementation of the suspension apparatus when there is a force to recline the backrest of the operator seat.

FIG. 9A is a side view of a second implementation of the suspension apparatus when there is no force to recline the backrest of the operator seat.

FIG. 9B is a side view of the second implementation of the suspension apparatus when there is a force to recline the backrest of the operator seat.

FIG. 10A is a side view of a third implementation of the suspension apparatus when there is no force to recline the backrest of the operator seat.

FIG. 10B is a side view of the third implementation of the suspension apparatus when there is a force to recline the backrest of the operator seat.

Like reference numerals are used to indicate like elements throughout the several figures.

### DETAILED DESCRIPTION

Present disclosure demonstrates different implementations of a suspension apparatus of an operator seat. However, other variations and modifications may be made without departing from the scope and spirit of the present disclosure. The suspension apparatus herein provides comfort for the operator when the operator is lying on a backrest of the operator seat.

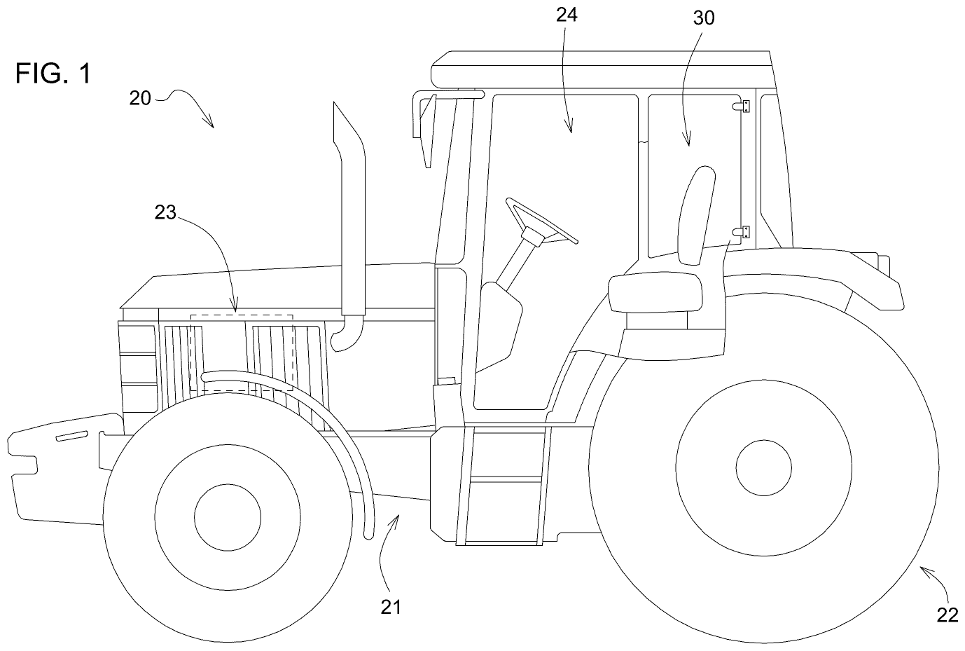

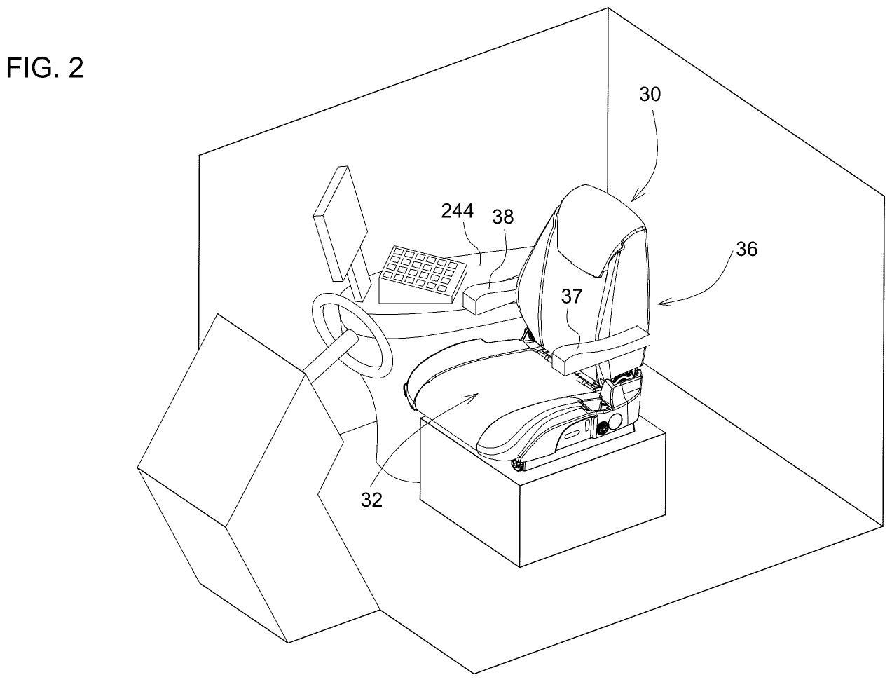

Referring to FIG. 1, a vehicle, embodied as a tractor 20, normally includes a mainframe 21, a ground engaging device 22, a power source 23, and a cab 24. The mainframe 21 is supported by the ground engaging device 22, which may be wheels, tracts, or other devices. The ground engaging device 22 engages the ground and is driven by the power source 23 to propel the tractor 20. The mainframe 21 may carry the power source 23, which may be a combustion engine or battery packs and motor(s). It is noted that other drivetrain components or electric vehicle components, includes but are not limited to transmissions, axles, differentials, hydraulic pumps, inverters, are omitted in FIG. 1. The mainframe 21 also supports the cab 24. Referring to FIGS. 1 and 2, the cab 24 provides an environment for the operator to sit and control the tractor 20. The cab 24 may include a console 244 on or near a side of an operator seat 30. The console 244 may include or are equipped with multiple input devices, including but not limited to touch screens, physical buttons, joysticks, and microphones. The console 244 may include or are equipped with multiple output devices, including but not limited to monitors (or touch screens) that coupled to a post(s) extending from the console 244.

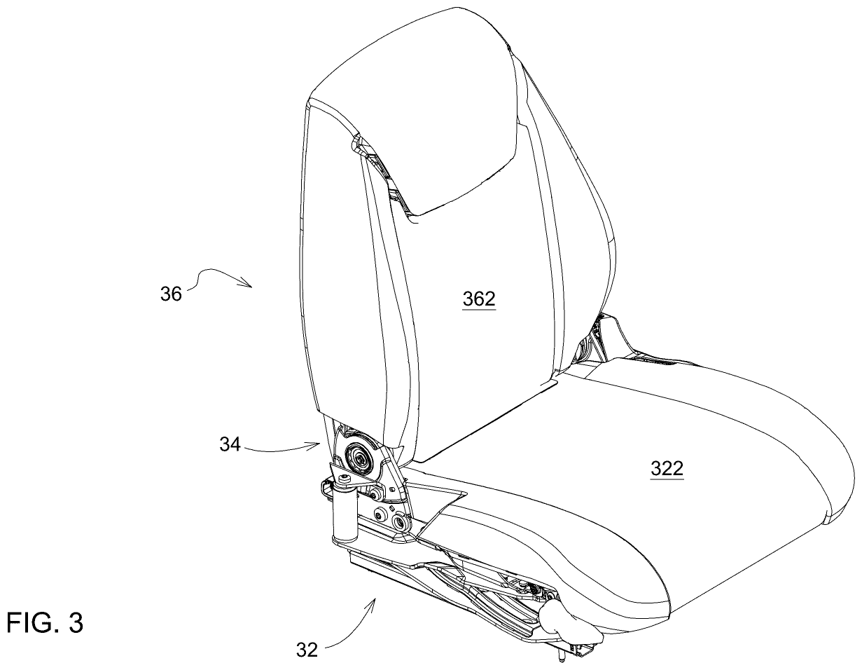

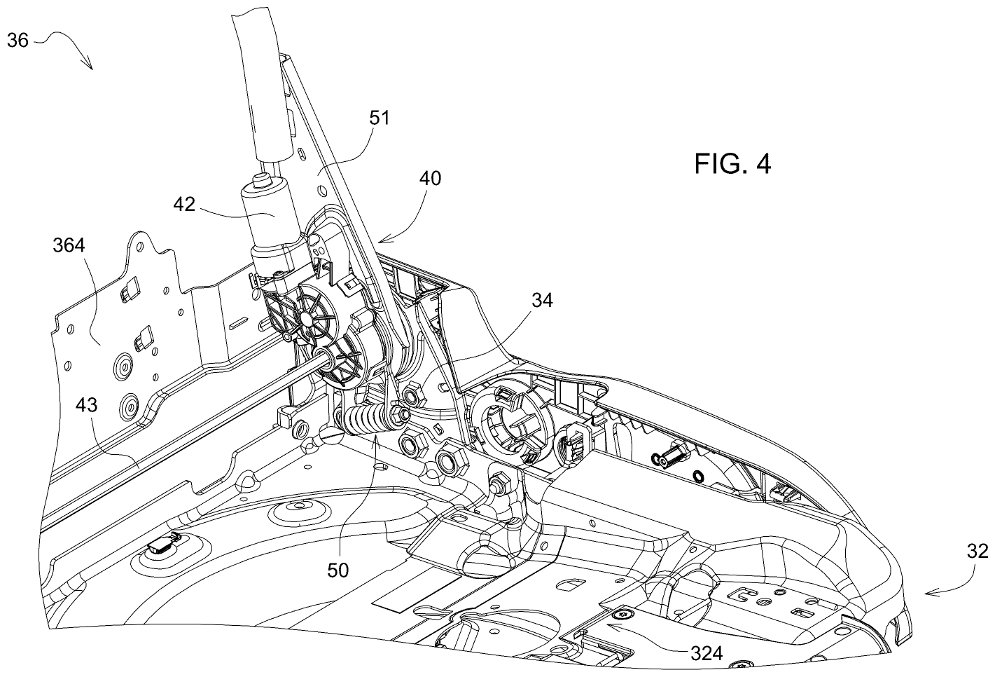

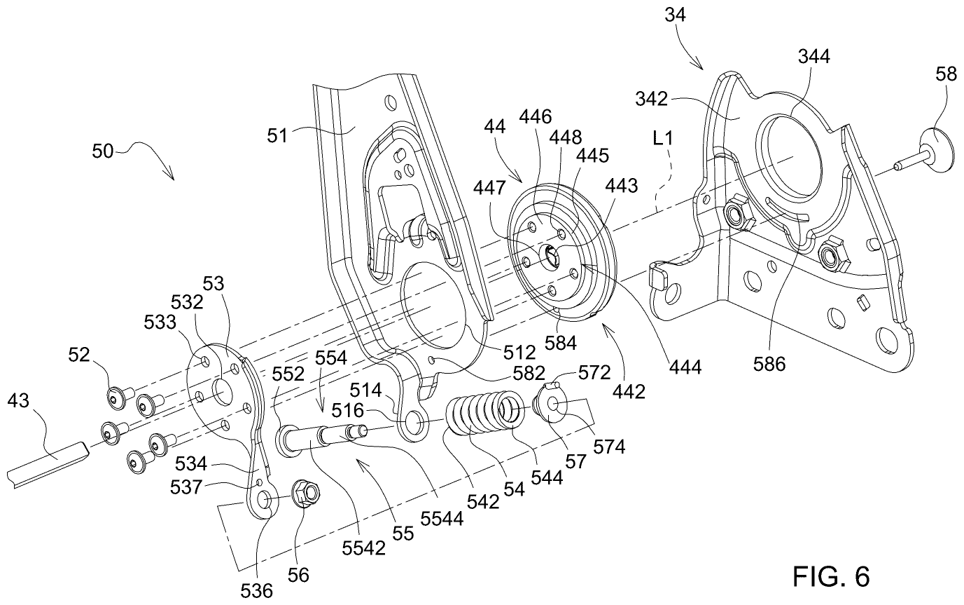

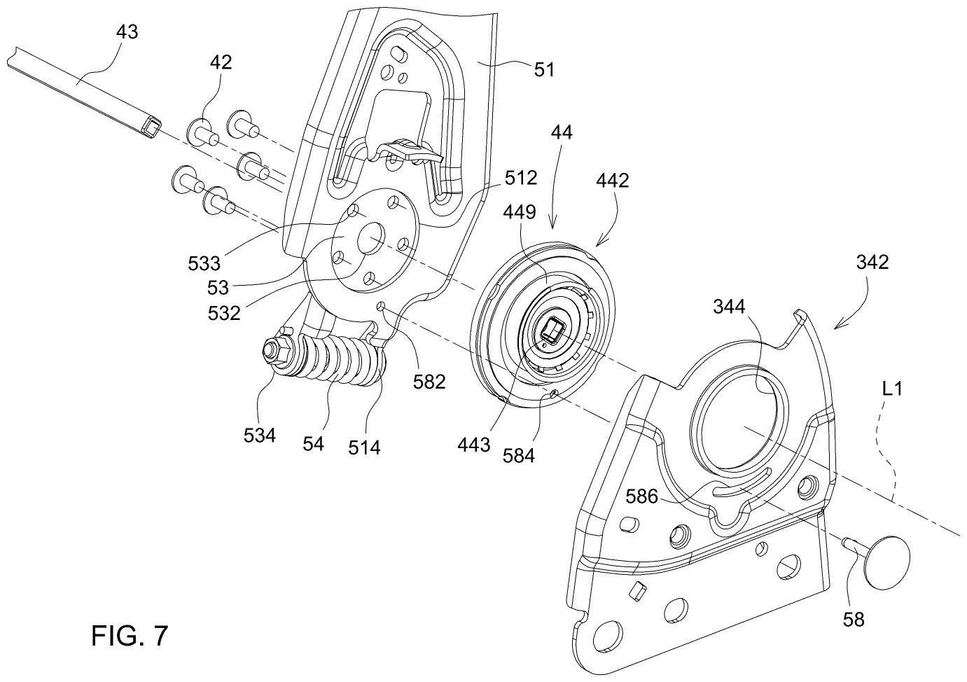

Referring to FIGS. 2-5, the operator seat 30 includes a seat base 32, a pair of supports 34, and a backrest 36. The seat base 32 has a cushion 322 and a base frame 324 coupled to the floor of the cab 24 and is at least partially covered by the cushion 322 (shown in FIG. 3). Each support 34 extends upward from a rearward portion of the seat base 32 and includes a stand 342 where a hole 344 is positioned, and one of the support 34 is illustrated in FIGS. 6 and 7. The backrest 36 is rotatably coupled to the seat base 32 with the support 34 and is reclinable relative to the seat base 32. The backrest 36 has a cushion 362 and a backrest frame 364 (shown in FIG. 4) coupled to the support 34 and is at least partially covered by the cushion 362 (shown in FIG. 3). Optionally, the operator seat 30 may also include a first arm 37 and a second arm 38 (shown in FIG. 2), which respectively extends from the sides of the backrest 36. The first arm 37 and the second arm 38 may allow the operator to place his or her arms for rest and are equipped with input devices for the operator to control the tractor 20.

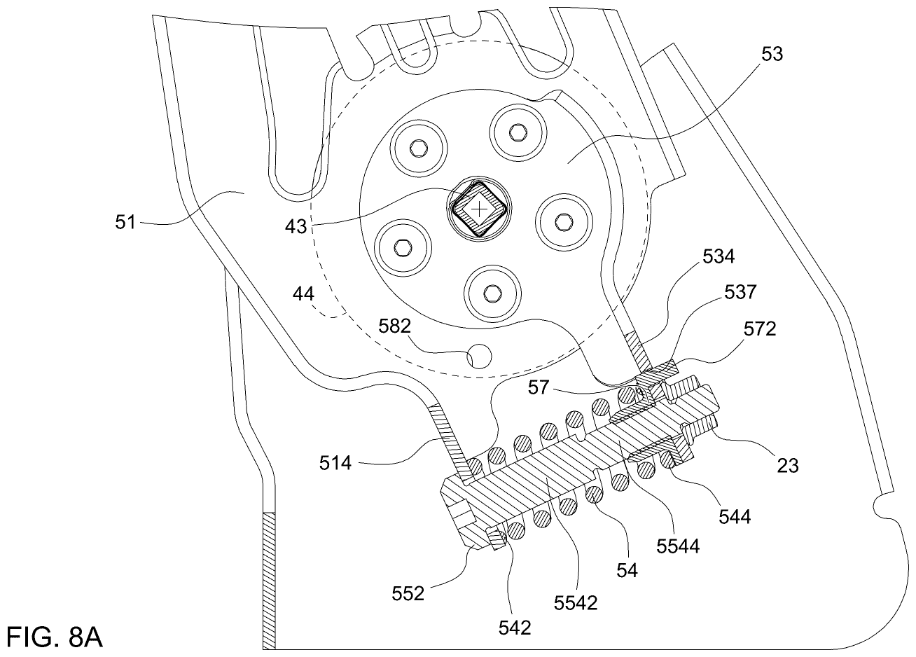

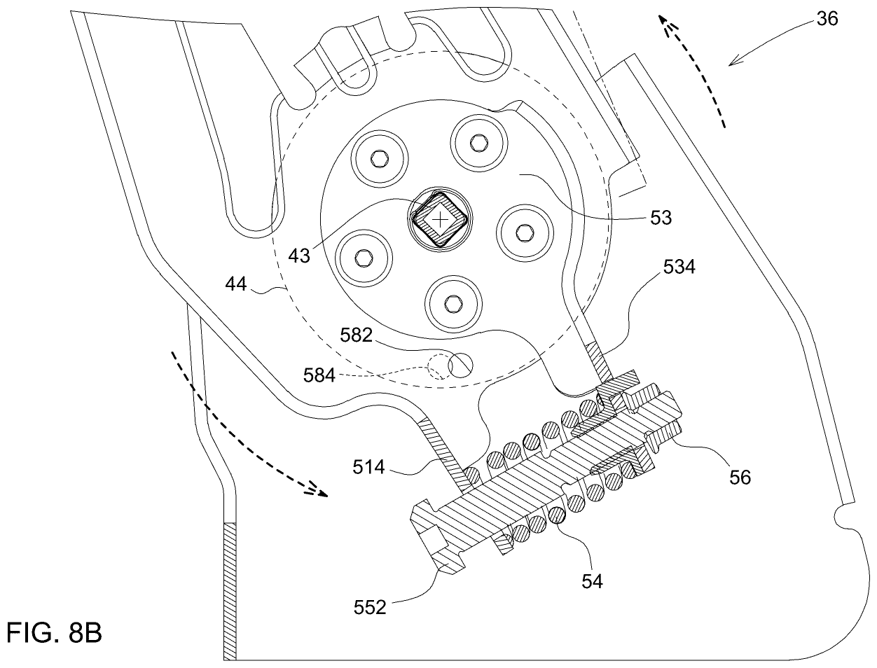

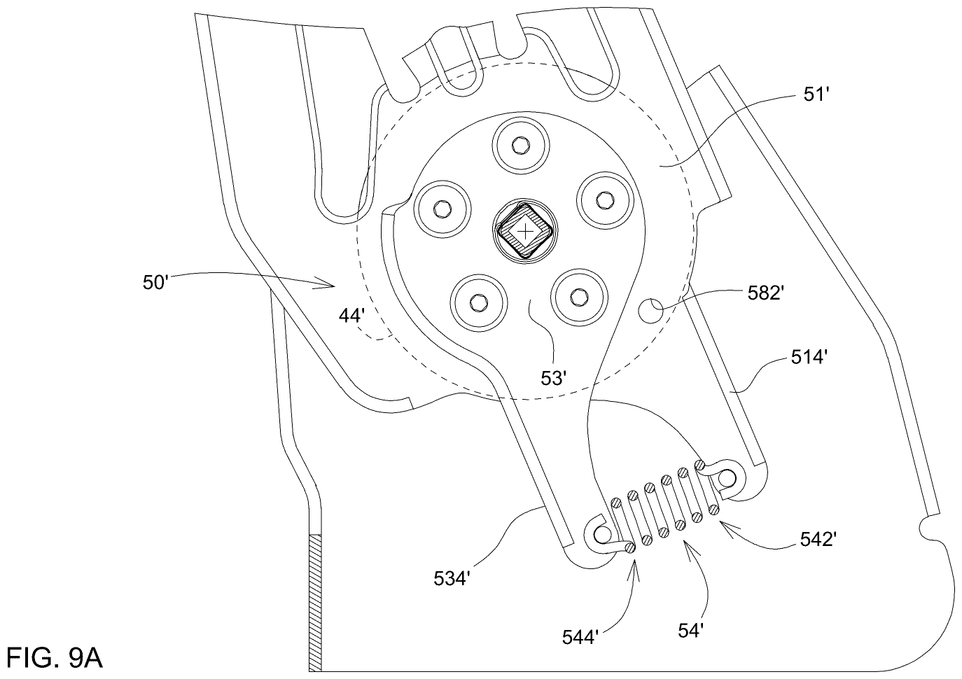

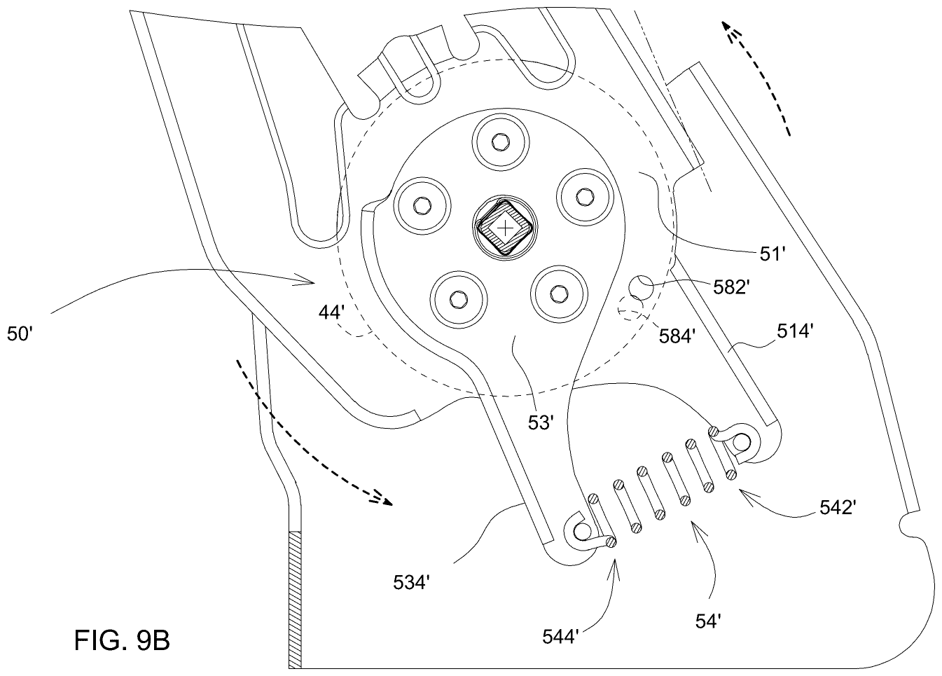

Referring to FIGS. 4-7, the operator seat 30 may include a reclination adjustment apparatus 40 operable to change the reclination angle between the seat base 32 and the backrest 36. The operator seat 30 may also include a suspension apparatus 50 coupled to the backrest 36 and operable to provide a suspension for a temporary increase at the reclination angle. As shown in FIG. 4, the reclination adjustment apparatus 40 includes an actuator 42, a connector 43 driven by the actuator 42, and a flange 44 (shown in FIG. 6). The actuator 42 may be a motor in as an example. The actuator 42 may rotate a drive shaft (not shown) and gears (not shown) in a gear box and finally rotate the connector 43. The connector 43 in this example is a tube with a square shape in its cross-sectional view (shown in FIGS. 8A-9B). The flange 44 includes a base 442 and a positioning hole 443, the shape of which matches an end of the connector 43. The end of the connector 43 and the positioning hole 443 are therefore interlocked. The flange 44, with the positioning hole 443, is coupled to the end of the connector 43. The flange 44 is also coupled to the support 34 with a sleeve 449 extending outward from the base 442 and inserting into the hole 344 of the stand 342. The flange 44 is rotatable relative to the support 34 around a first axis L1. The actuator 42 drives the connector 43 to rotate the flange 44 relative to the support 34. The rotation of the flange 44 rotates the suspension apparatus 50, which is coupled to the backrest 36, to change the reclination angle between the seat base 32 and the backrest 36. In this example, the operator may use an accessible input device to control the actuator 42 to change the reclination angle. However, in another example, the operator may manually rotate the flange 44, through a lever or pushing the backrest 36 with a latch used for maintaining the position of the backrest 36 unlatched, to change the reclination angle. The flange 44 extends inward to form a platform 444 interacting with the suspension apparatus 50. It is noted that the term “inward” is descriptively defined in a lateral direction from one side of the operator seat 30 to the center of the operator seat 30 for illustration purpose. Likewise, the term “outward” is descriptively defined in a lateral direction from the center of the operator seat 30 to one side of the operator seat 30 for illustration purpose. The platform 444 includes a rim 445, a surface 446 facing inward, a hole 447 connected to the positioning hole 443, and holes 448 located on the surface 446, which are described together with the components of the suspension apparatus 50.

The suspension apparatus 50 includes a bracket 51, fasteners 52, and a retaining piece 53. The bracket 51 is coupled to one side of the backrest 36, rotatable with the flange 44 with the suspension allowing a limited rotation relative to the flange 44 around the first axis L. The bracket 51 has an aperture 512 near the bottom thereof. The retaining piece 53 includes an aperture 532 that is co-axial with the aperture 512 of the bracket 51 and the hole 447 and is used for the connector 43 passing through. The retaining piece 53 may also include holes 533 surrounding the aperture 532. The retaining piece 53 is connected to the platform 444 of the flange 44 by the fasteners 52 passing through the holes 533 of the retaining piece 53, through the aperture 512 of the bracket 51, and inserting in the holes 448 of the flange 44. The fasteners 52 are screws in this example but may be other type of fasteners combining the retaining piece 53 and the flange 44. The bracket 51 is positioned between the base 442 of the flange 44 and the retaining piece 53. The rim 445 of the platform 444 inserts to the aperture 512 of the bracket 51, and the bracket 51 is rotatable in the limited rotation relative to the rim 445 of the flange 44.

In the first implementation, the suspension apparatus 50 includes an elastic component such as a spring 54. The spring 54 has a first end 542 coupled to bracket 51 and a second end 544 coupled to the retaining piece 53 to resist the bracket 51 from the limited rotation through a spring force from the spring 54. The bracket 51 extends a first lobe 514 and the retaining piece 53 extends a second lobe 534 spaced apart from the first lobe 514 with a distance, as shown in FIG. 8A. The first lobe 514 includes a hole 516. The second lobe 534 includes a hole 536 and, optionally, a locking hole 537. The suspension apparatus 50 may also include a bolt 55 having a bolt head 552, a body 554 connected to the bolt head 552, and a nut 56 rotatably placed on the body 554 of the bolt 55. The body 554 of the bolt 55 is positioned through the hole 516 of the first lobe 514 and the hole 536 of the second lobe 534. The spring 54 surrounds body 554 of the bolt 55 and is positioned between the bolt head 552 and the nut 56. The bolt 55 is turnable relative to the nut 56 to change a pre-load of the spring 54. In this example, the bolt head 552 engages the bracket 51 and the nut 56 engages the retaining piece 53. The first lobe 514 is positioned between the first end 542 of the spring 54 and the bolt head 552, and the second lobe 534 is positioned between the second end 544 of the spring 54 and the nut 56. Referring to FIGS. 8A and 8B, the spring 54 is a compression spring and is configured to provide the suspension to absorb impact resulted from, for instance, the operator suddenly laying on the backrest 36. As shown in FIG. 8B, the impact increases the reclination angle between the backrest 36 and the seat base 32 (the backrest 36 rotates counterclockwise) and decreases the distance when the first lobe 514 moves toward the second lobe 534.

Optionally, the body 554 of the bolt 55 includes a first shoulder 5542 and a second shoulder 5544. One end of the first shoulder 5542 is connected to the bolt head 552, and the second shoulder 5544 is connected to the other end of the first shoulder 5542. The diameter of the second shoulder 5544 is smaller than the diameter of the first shoulder 5542. The suspension apparatus 50 includes a collar 57 abutting the second lobe 534 with the nut 56 on the opposite side of the second lobe 534 and pressing the second end 544 of the spring 54. The collar 57 is moveable along the second shoulder 5544 of the body 554 to compress the spring 54 with a boundary at the first shoulder 5542 for a maximum pre-load setting. The collar 57 may extend a pin 572 passing through a locking hole 537 of the second lobe 534 near the hole 536 so as to prevent the rotation of the collar 57 relative to the body 554 of the bolt 55.

In another example (not shown), where the bolt 55 is disposed in an opposite feature—the first lobe 514 is positioned between the first end 542 of the spring 54 and the nut 56, and the second lobe 534 is positioned between the second end 544 of the spring 54 and the bolt head 552. The collar 57 in this example abuts the first lobe 514 with the nut 56 on the opposite side of the first lobe 514 and pressing the first end 542 of the spring 54. Like previous example, the collar 57 is moveable along the second shoulder 5544 of the body 554 to compress the spring 54 with a boundary at the first shoulder 5542 for a maximum pre-load setting (not shown).

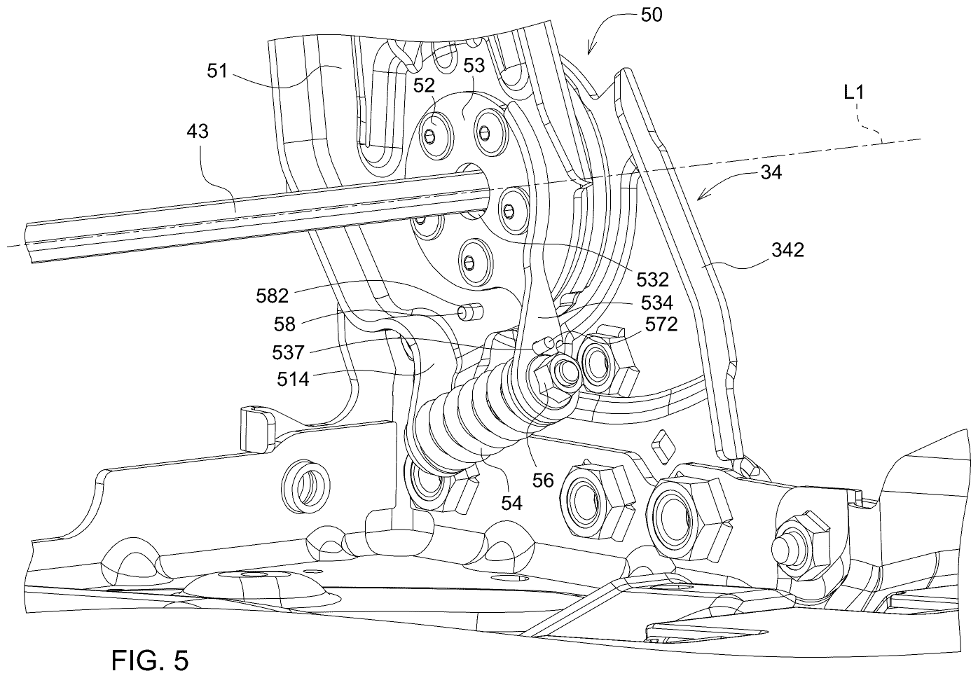

Optionally, referring to FIGS. 5, 6 and 7, the suspension apparatus 50 may include a lock-out device 58. The lock-out device 58 engages between the bracket 51 and one of the flange 44 and/or retaining piece 53 and is configured to prevent the bracket 51 from the limited rotation relative to the flange 44 around the first axis L1. Here, as shown in FIGS. 6 and 7, a lock-out device 58 may be a pin. The bracket 51 has a hole 582, the flange 44 has a hole 584, and the stand 342 has a curved slot 586. The holes 582, 584, and the curved slot 586 are used for the lock-out device 58 to pass through to prevent relative movement between the bracket 51 and the flange 44. The curved slot 586 allows the lock-out device 58 to insert into the holes 582, 584, even if the flange 44 rotates relative to the stand 342 in another position. When the lock-out device 58 is removed, as shown in FIGS. 8A and 8B, the bracket 51 can rotate relative to the flange 44 around the first axis L1. The holes 582, 584 do not completely overlap after the relative movement between the bracket 51 and the flange 44 (and retaining piece 53), as shown in FIG. 8B. It is noted that the lock-out device may be other types, including but limited to a latch (not shown).

In the second implementation, as shown in FIGS. 9A, a suspension apparatus 50′ includes an elastic component such as a spring 54′. Unlike the first implementation, the spring 54′ is the expansion spring. The spring 54′ is configured to provide the suspension to absorb impact resulted from, for instance, the operator suddenly laying on the backrest 36. A bracket 51′ extends a first lobe 514′ and a retaining piece 53′ extends a second lobe 534′ spaced apart from the first lobe 514′ with a distance. The main difference between the first implementation and the second implementation is the relative position between the first lobes 514, 514′ and the second lobes 534, 534′. In the first implementation, the first lobe 514′ is behind the second lobe 534′. In second implementation the first lobe 514′ is in front of the second lobe 534′. The spring 54′ has a first end 542′ coupled to the first lobe 514′ of the bracket 51′ through a hook and a second end 544′ coupled to the second lobe 534′ of the retaining piece 53′ through another hook. As shown in FIG. 9B, the impact increases the reclination angle between the backrest 36 and the seat base 32 (the backrest 36 rotates counterclockwise) and increase the distances when the first lobe 514′ moves away from the second lobe 534′. Like the first implementation, when the lock-out device 58 is removed, as shown in FIGS. 9A and 9B, the bracket 51′ can rotate relative to the flange 44′ around the first axis L1. The holes 582′, 584′ do not completely overlap after the relative movement between the bracket 51′ and the flange 44′ (and retaining piece 53′), as shown in FIG. 8B.

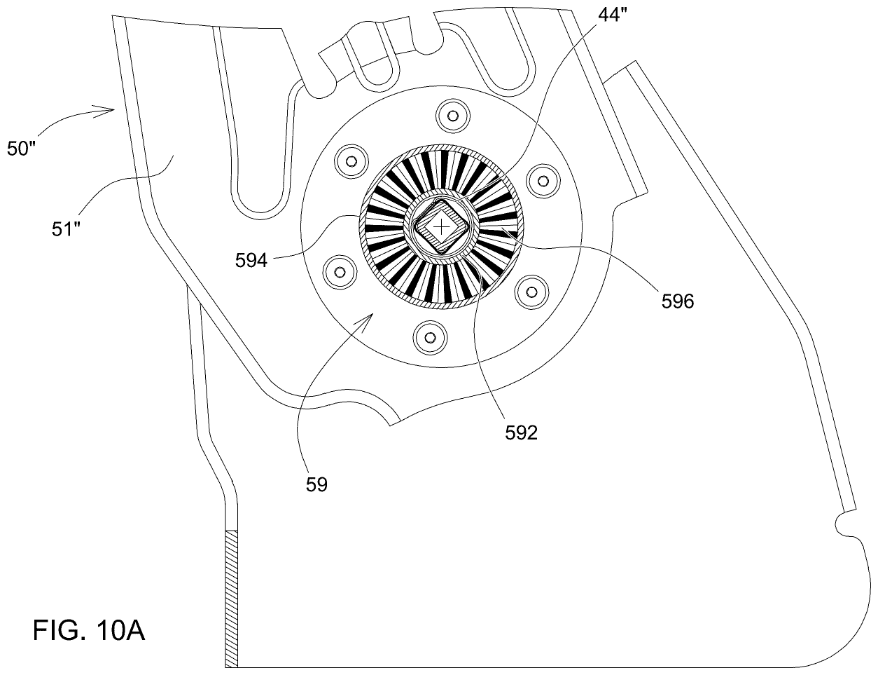

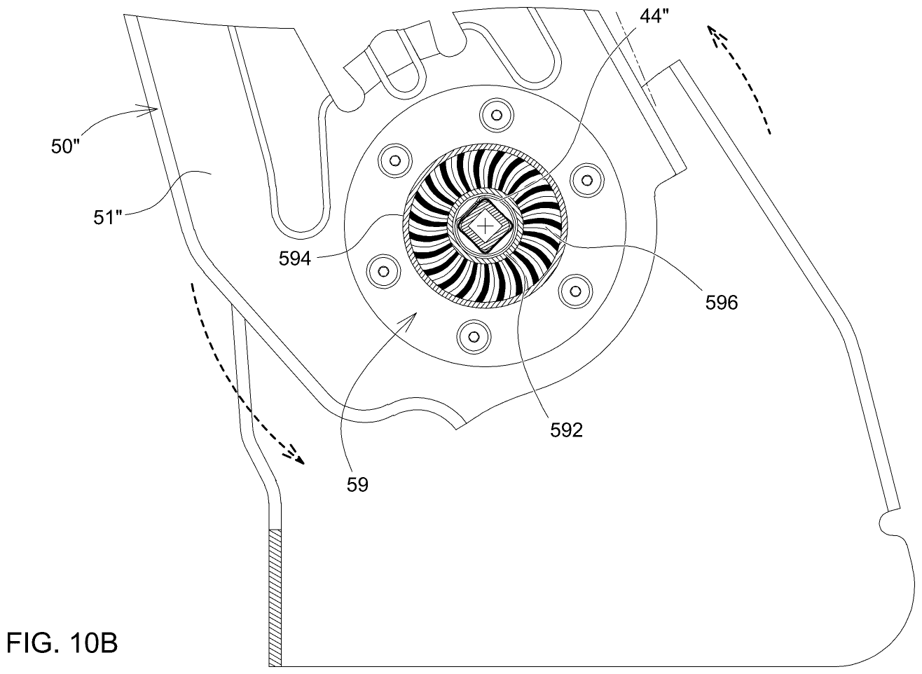

In the third implementation, as shown in FIGS. 10A and 10B, a suspension apparatus 50″ includes an elastic component such as elastomer bushing 59. The elastomer bushing 59 includes an inner sleeve 592 coupled to a flange 44″ (like the flange 44), an outer sleeve 594 coupled to a bracket 51″ (similar to the bracket 51 except the first lobe 514), and an elastomer 596. The elastomer 596 is positioned between the inner sleeve 592 and the outer sleeve 594 and is configured to provide the suspension. As shown in FIG. 10B, the impact increases the reclination angle between the backrest 36 and the seat base 32 (the backrest 36 rotates counterclockwise) and deforms the elastomer 596, and a suspension is provided therefrom.

It is noted that only one of the suspension apparatus 50, 50′, 50″ is shown on or near one side of the operator seat 30. The other side of the operator seat 30 may also include one of the suspension apparatus 50, 50′, 50.″

Without in any way limiting the scope, interpretation, or application of the claims appearing below, a technical effect of one or more of the example embodiments disclosed herein is to provide suspension of the operator seat. Another technical effect of one or more of the example embodiments disclosed herein is to allow the operator to determine the reclination angle between the backrest and the seat base with additional suspension.

As used herein, “e.g.” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

Those having ordinary skill in the art will recognize that terms such as “above,” “below,” “upward,” “downward,” “inward,” “outward,” “top,” “bottom,” etc., are used descriptively for the figures, and do not represent limitations on the scope of the disclosure, as defined by the appended claims.

Terms of degree, such as “generally,” “substantially” or “approximately” are understood by those of ordinary skill to refer to reasonable ranges outside of a given value or orientation, for example, general tolerances or positional relationships associated with manufacturing, assembly, and use of the described embodiments.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. An operator seat of a work vehicle, comprising:
a seat base having a base frame;
a support extending upward from a rearward portion of the seat base;
a backrest rotatably coupled to the seat base with the support and reclinable relative to the seat base;
a flange coupled to the support and rotatable relative to the support around a first axis; and
a suspension apparatus coupled between the flange and the backrest to provide rotation between the flange and the backrest around the first axis;
wherein rotation of the flange rotates the suspension apparatus.

2. The operator seat of claim 1, wherein the suspension apparatus comprises:
a bracket coupled to a side of the backrest, rotatable with the flange with a suspension allowing a limited rotation relative to the flange around the first axis, and having an aperture;
a fastener; and
a retaining piece connected to the flange by the fastener passing through the aperture of the bracket;
wherein the bracket is positioned between the flange and the retaining piece.

3. The operator seat of claim 2, wherein the suspension apparatus includes a spring having a first end coupled to the bracket and a second end coupled to the retaining piece to resist the bracket from the limited rotation through a spring force from the spring.

4. The operator seat of claim 3, wherein the suspension apparatus includes:
a bolt having a bolt head and a body connected to the bolt head; and
a nut;
wherein the spring surrounds the body of the bolt and is positioned between the bolt head and the nut, and one of the bolt head and the nut engages the bracket and the other one of the bolt head and the nut engages the retaining piece;
wherein the bolt is turnable relative to the nut to change a pre-load of the spring.

5. The operator seat of claim 4, wherein the bracket extends a first lobe and the retaining piece extends a second lobe spaced apart from the first lobe with a distance; wherein the first lobe is positioned between the first end of the spring and one of the bolt head and the nut, and the second lobe is positioned between the second end of the spring and the other one of the bolt head and the nut.

6. The operator seat of claim 5, wherein the spring is a compression spring and is configured to provide the suspension to absorb impact that increases a reclination angle between the backrest and the seat base and decreases the distance when the first lobe moves toward the second lobe.

7. The operator seat of claim 6, wherein the body of the bolt includes a first shoulder, one end of the first shoulder connected to the bolt head, and a second shoulder connected to another end of the first shoulder, a diameter of the second shoulder smaller than a diameter of the first shoulder, and the suspension apparatus includes a collar abutting one of the first lobe and the second lobe with the nut on an opposite side relative to the first lobe or the second lobe, pressing one of the first end and the second end of the spring, and moveable along the second shoulder to compress the spring with a boundary at the first shoulder for a maximum pre-load setting.

8. The operator seat of claim 3, wherein the spring is an expansion spring and is configured to provide the suspension to absorb impact that increases a reclination angle between the backrest and the seat base.

9. The operator seat of claim 8, wherein the bracket extends a first lobe and the retaining piece extends a second lobe spaced apart from the first lobe with a distance; wherein the first end of the spring is connected to the first lobe and the second end of the spring is connected to the second lobe.

10. The operator seat of claim 2, further comprising a reclination adjustment apparatus including the flange, an actuator, and a connector driven by the actuator;
wherein the flange is coupled to an end of the connector, and the actuator drives the connector to rotate the flange relative to the support.

11. The operator seat of claim 2, wherein the flange protrudes inward a platform having a rim inserting to the aperture of the bracket, and the bracket is rotatable in the limited rotation relative to the rim of the flange.

12. The operator seat of claim 11, wherein the retaining piece is connected to the platform of the flange through the fastener.

13. The operator seat of claim 2, further comprising a lock-out device engaging between the bracket and one of the flange and the retaining piece and configured to prevent the bracket from the limited rotation relative to the flange around the first axis.

14. The operator seat of claim 1, wherein the suspension apparatus includes an elastomer bushing coupled between the flange and the backrest.

15. The operator seat of claim 14, wherein the suspension apparatus includes a bracket coupled to a side of the backrest, reclinable with the flange with the suspension allowing a limited rotation relative to the flange around the first axis;
wherein the elastomer bushing includes an inner sleeve coupled to the flange, an outer sleeve coupled to the bracket, and an elastomer positioned between the inner sleeve and the outer sleeve and configured to provide the suspension.
